(19) United States
(12) Patent Application Publication
(10) Pub. No.: US 2025/0335322 A1
(43) Pub. Date: Oct. 30, 2025

(54) Method for Fault Tolerant Implementation of a Mapping of at Least One Input Value to at Least One Output Value by a Processing Assembly having a Plurality of Processing Units and a Processing Assembly

(71) Applicant: Robert Bosch GmbH, Stuttgart (DE)

(72) Inventors: Cecilia Eugenia De La Parra Aparicio, Herrenberg (DE); Dennis Sebastian Rieber, Albstadt (DE); Jan Micha Borrmann, Mannheim (DE); Michael Beyer, Stuttgart (DE)

(21) Appl. No.: 19/190,687

(22) Filed: Apr. 27, 2025

(30) Foreign Application Priority Data
Apr. 29, 2024 (DE) 10 2024 204 008.8

(51) Int. Cl. G06F 11/30; G06F 11/34

(52) U.S. Cl. CPC G06F 11/3062; G06F 11/3447

(57) ABSTRACT

A method for fault tolerant implementation of a mapping of at least one input value to at least one output value by a processing assembly with a plurality of processing units is disclosed. The mapping includes a plurality of structures with computational operations which can be evaluated by one or more of the processing units. Each of the structures is associated with criticality information that includes information how critical the error-free evaluation of the structure is for the error-free evaluation of the mapping. If at least one processing unit has a malfunction, at least one structure is selected based on the criticality information of the structures. It is determined whether the at least one structure should be evaluated in a modified manner or not evaluated. The mapping is applied to input values, wherein the selected at least one structure is evaluated in a modified manner or is not evaluated.

This application claims priority under 35 U.S.C. § 119 to application no. DE 10 2024 204 008.8, filed on Apr. 29, 2024 in Germany, the disclosure of which is incorporated herein by reference in its entirety.

The present disclosure relates to a method for fault tolerant implementation of a mapping of at least one input value to at least one output value by a processing assembly having a plurality of processing units, as well as a computing unit and a computer program for carrying out the same and a processing assembly.

### BACKGROUND

Dedicated hardware accelerators in the form of integrated circuitry can be used for computationally intensive computer applications, e.g., in the field of artificial intelligence or neural networks. Such hardware accelerators may include a plurality of processing units that perform calculation structures commonly encountered in neural networks, such as elementary operations like multiply-add operations. Accelerators may also comprise a variety of simple, programmable processing units, e.g., so-called shader cores. A high computational speed is, in particular, achieved by parallel execution in the plurality of processing units. In order to keep the power consumption and cost of such hardware accelerators low, the integrated circuitry may be made with the smallest structure sizes as possible. These are, however, more prone to hardware failure. In addition to temporary errors, e.g., bit flips, permanent errors can also occur, e.g., due to variations in the manufacturing process or due to aging processes.

### SUMMARY

According to the present disclosure, a method for fault tolerant implementation of a mapping of at least one input value to at least one output value by a processing assembly having a plurality of processing units as well as a computing unit and a computer program for carrying out the same and a processing assembly with the features set forth below is proposed. Advantageous configurations are the subject matter of the following description.

The disclosure makes use of the measure for mapping at least one input value to at least one output value, implemented by a processing assembly having a plurality of processing units and comprising a plurality of structures with computational operations, which may be evaluated by one or more of the processing units, to assign criticality information to each of the structures, which includes information about how critical the error-free evaluation of the structure is for the error-free evaluation of the mapping. If at least one processing unit has a malfunction, at least one structure is selected based on the criticality information of the structures, wherein it is determined whether the at least one structure should be evaluated in a modified manner or not, and the mapping is applied to input values, wherein the selected at least one structure is evaluated differently or is not evaluated according to the previously performed determination. A malfunction of a processing unit exists in particular if results calculated by it are not correct. For example, the execution or evaluation of a calculation implemented by the processing unit can be initiated with input values for which the result or the output values are known. Then, a comparison of the currently determined output values with the known output values can be used to determine whether there is a malfunction.

Through the disclosure, if errors occur in one or more of the processing units, the mapping may be further implemented by the processing assembly in such a way that a mapping error is kept as small as possible. The function of the processing assembly can thus be maintained, which is important for example in safety-critical applications, e.g., in automotive applications in the context of functional safety. A redundant design, in which the processing assembly is provided twice or at least several of its processing units are provided multiple times, can be largely omitted. It is noted that a technical system, such as a vehicle or robot or manufacturing machine or medical machine, can be controlled depending on an output of the processing unit.

A structure can comprise any operation or calculation, for example a relatively elementary operation, such as a multiplication, addition, or multiply-add operation, or also a compound operation that includes a plurality of elementary operations. In a neural network in which images are processed using different color channels, for example, the processing of a color channel may represent a composite operation.

The term “figure” is generally to be understood as a figure or function that maps the input value to output values. In particular, the mapping implements a neural network, wherein the structures include weights and multiplications with weights, neurons, layers, or channels. For example, the structures may be multiply-add operations, wherein the processing units are configured to perform multiply-add operations.

According to one configuration, the criticality information of each structure comprises a relevance value, wherein the at least one structure is selected according to the relevance values of the structures. In particular, the selected at least one structure has a lowest relevance value and/or a relevance value below a predetermined relevance value threshold. It is hereby assumed that structures with a higher relevance value are more important or more critical for the accuracy of the mapping.

According to one configuration, the criticality information of each structure comprises an error measure that indicates an expected average or maximum error of the mapping when the structure is evaluated in a modified manner or is not evaluated. The expected or estimated average or maximum mapping error may be calculated and/or determined by testing, for example, prior to employing the mapping or the processing assembly. In the event that the mapping is a neural network or is generally a machine learning-based mapping, for example, training data that was used for training may be used. A plurality of error measures can be associated with each structure, such as an error measure for the non-evaluation of the structure and an error measure for the changed evaluation.

According to one configuration, the at least one structure is selected according to the error measures of the structures, wherein the selected at least one structure in particular has a low error measure and/or an error measure below a predetermined error measure. It is assumed here that a small error measure corresponds to a small error in the mapping in the event of non-evaluation or a changed analysis of a structure.

According to one configuration, an expected overall error of the mapping is determined based on the error measure of the selected at least one structure, wherein, in particular, the expected overall error is output and/or transmitted to a function module that processes the result of the mapping. The total error can be determined by addition, for instance, or by using a suitable statistical method for error estimation or failure propagation.

According to one configuration, each processing unit is configured to evaluate a structure or a portion thereof with different accuracies, and set up to evaluate the structure with reduced accuracy in case of a partial malfunction of the processing unit and/or evaluate the structure twice or several times in parallel with reduced accuracy, wherein the selected at least one structure is evaluated differently, namely with reduced accuracy. For example, in the case of a partial malfunction of a processing unit, a (selected) structure may be evaluated with reduced accuracy by the processing unit. For example, if one processing unit malfunctions completely, two (selected) structures may be evaluated in parallel with reduced accuracy by another (fully operable) processing unit.

According to one configuration, the criticality information of each structure comprises accuracy loss information indicative of an accuracy loss of the structure during the evaluation with reduced accuracy (compared to a full accuracy evaluation). The at least one structure is selected in particular according to the accuracy loss information of the structures. In particular, the selected at least one structure has a low accuracy loss and/or an accuracy loss below a predetermined accuracy loss threshold. In addition, the error measure of the criticality information may be determined from the accuracy loss information and optionally used to select the at least one structure.

According to one configuration, the different accuracies correspond to different quantizations of values, in particular different bit widths. For example, a processing unit may be configured to perform a multiplication or multiply-add operation (i.e., the entries of two input vectors are multiplied in pairs and the products are added up) with full bit width (e.g., 8 bits) or half bit width (e.g., 4 bits), wherein, at full bit width, a pair having two binary values, which have the full bit width (and which are multiplied by one another) is processed and at half bit width two pairs of two binary values, having half the bit width (and which are multiplied by one another) are processed in parallel. The processing unit may comprise about four sub-processing units, which evaluate multiplications with half bit width, wherein in the case of processing with full bit width, the results of the multiplications with half bit width are added appropriately weighted. If only one of these sub-processing units is faulty, the processing may still be performed with half the bit width.

According to one configuration, the criticality information of each structure includes correlation information, which indicates at least one other structure, whose result values are strongly correlated to the result values of the structure, wherein, when applying the mapping to the input values, the at least one structure is not evaluated and estimated result values are determined from result values of the at least one other structure using the correlation information, which is used instead of the result values of the non-evaluated structure. Depending on the strength of the correlation, a greater or smaller error occurs with this configuration in the estimated result values. It can be provided that structures are only considered to be strongly correlated if the amount of the correlation (e.g., which takes values between −1 and +1) is greater than a predetermined minimum correlation (e.g., 0.7, 0.8, or 0.9).

According to one configuration, the criticality information of each structure includes resource information indicating which computational power resources are conserved and to what extent if the structure is not evaluated or is evaluated in a modified manner. In this case, a computational power loss, which is due to the malfunction of the at least one processing unit, is expediently determined. In particular, the at least one structure is selected such that the saved computing power resources balance out or balance out the computing power loss within a predetermined tolerance. For example, the resource information may indicate how much computational time is saved in relation to a processing unit.

According to one configuration, a distribution table assigning structures to processing units is provided, wherein the distribution table is modified so that the selected at least one structure is not evaluated or is evaluated in a modified manner. According to an alternative configuration, a distribution function is implemented; wherein structures to be carried out are dynamically assigned processing units in consideration of the criticality information, in particular wherein the at least one structure is selected in response to an application duration of the mapping reaching or exceeding a predetermined maximum duration. Through these configurations, the transition can be effectively implemented in the event of a malfunction to evaluate the mapping, with a different evaluation or non-evaluation of a structure.

A computational unit according to the disclosure, e.g., a system-on-chip (SoC), a (heterogeneous) multi-to manycore system, an accelerator board (such as, for instance, GPCPU) and or a chiplet implementation, in particular in a control device in an automobile that implements control functions by way of a neural network and that includes or controls a processing assembly with a plurality of processing units, is configured, in particular programmed, to perform a method according to the disclosure.

The implementation of a method according to the disclosure in the form of a computer program or computer program product comprising program code for performing all of the method steps is also advantageous because this results in particularly low costs, especially if an executing control device is still used for other tasks and is therefore provided in any event. Lastly, a machine-readable storage medium is provided, on which a computer program as described above is stored. Suitable storage media or data carriers for providing the computer program are, in particular, magnetic, optical, and electric storage media, such as hard disks, flash memory, EEPROMs, DVDs, and others. Downloading a program via computer networks (internet, intranet, etc.) is also possible. Such a download can take place in a wired, or cabled, or wireless manner (e.g., via a WLAN, a 3G, 4G, 5G, or 6G connection, etc.).

Further advantages and embodiments of the disclosure will emerge from the description and the accompanying drawings.

The disclosure is shown schematically in the drawings on the basis of exemplary embodiments and is described hereinafter with reference to the drawings.

### BRIEF DESCRIPTION OF THE DRAWINGS

FIG. 1 shows a processing assembly having a plurality of processing units.

FIG. 2 shows a flow chart of a method for fault tolerant implementation of a mapping by a processing assembly having a plurality of processing units according to embodiments of the disclosure.

For example, FIG. 3 illustrates the structure of a neural network.

FIG. 4 illustrates the determination of neuron evaluation errors with reduced accuracy.

### DETAILED DESCRIPTION

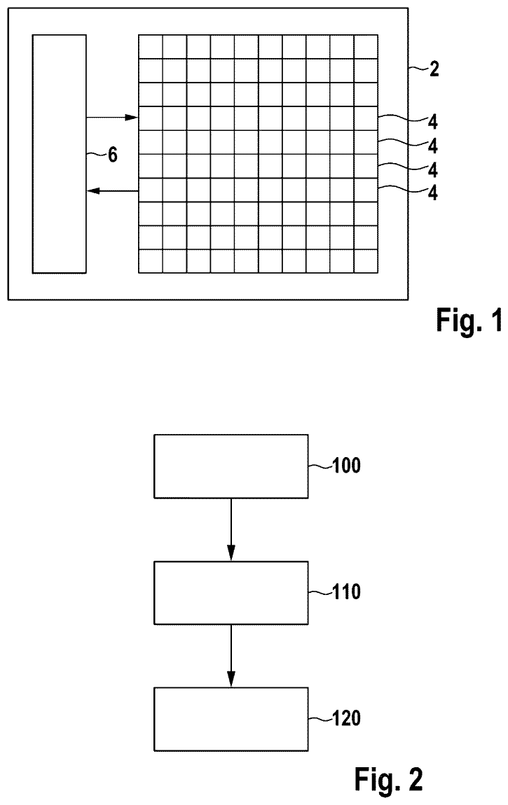

FIG. 1 shows a processing assembly 2 having a plurality of processing units 4. The processing units 4 are, for example, hardware processing units that implement certain calculations in hardware, i.e., by a corresponding arrangement of circuit elements. The processing units 4 may also comprise (relatively simple) computational cores (e.g., so-called shader cores) that implement calculations by executing programs.

Further, the processing assembly 2 may comprise a control unit 6 that controls the processing units 4, i.e., in particular, transmitting respective input values to the processing unit 4 for each processing unit 4, or causing them to be loaded into the processing unit 4, which causes the processing unit 4 to process the input values and receive and/or store output values from the processing unit 4 and/or transmit them to a (different) processing unit 4 as input values for subsequent calculations.

The processing assembly 2 may generally comprise any number of processing units 4, in particular several hundred or over a thousand processing units. The processing units 4 and optionally the control unit 6 can be disposed on a single chip, for example.

It is possible that an error, particularly a hardware error, occurs in a single processing unit or in a few processing units. One type of error may cause the affected processing unit to fail completely. Another type of error may result in the affected processing unit failing in part, such that calculations performed by it may in particular be performed only with reduced accuracy (instead of full accuracy). The method according to the disclosure can achieve that a mapping to at least one output value implemented by the processing assembly 2, e.g., in the form of a neural network or a mapping generally based on machine learning, may, however, continue to be evaluated or used in the event of a malfunction in one or more processing units, wherein a mapping error resulting from the malfunction remains as small as possible.

FIG. 2 shows a flow chart of a method for fault tolerant implementation of a mapping of at least one input value to at least one output value by a processing assembly having a plurality of processing units according to embodiments of the disclosure. For example, the method may be performed by a control unit of the processing assembly.

In an optional step 100, failure detection is performed in which processing units having a malfunction in the form of a complete or partial failure are determined. To this end, the execution or evaluate a calculation implemented by the processing unit with input values for which the result and/or the output values are known is initiated in each of the processing units, for example. Then, a comparison of the currently determined output values with the known output values can be used to determine whether there is a malfunction and what the malfunction is. This procedure can be performed, for example, at certain intervals or at certain times (e.g., when the processing assembly is turned on). Corresponding data about malfunctions indicative of the malfunction of processing units may be stored so that step 100 is performed only optionally and otherwise previously known data about malfunctions may be used, e.g., stored data may be read.

It is further assumed that the processing assembly implements mapping comprising a plurality of structures with computational operations. The structures can be considered as partial mappings or partial functions, which at least partially form the mapping. The structures may be evaluated by one or more of the processing units, i.e., the evaluation of a structure may be optionally assigned to one or more of the processing units. Each of the structures is associated with criticality information including information on how critical the error-free evaluation of the structure is for the error-free evaluation of the mapping. The criticality information may also be considered as information indicating to what extent a faulty evaluation causes a mapping error. The criticality information is determined in particular offline.

In step 110, if at least one processing unit has a malfunction, at least one structure is selected based on the criticality information of the structures. It is also determined whether the at least one structure should be evaluated in a modified manner or not evaluated. In particular, the at least one structure is selected so that it or its evaluation is of the lowest possible criticality for the error-free evaluation of the mapping.

In step 120, the mapping is applied to input values, wherein the selected at least one structure (as determined in step 110) is evaluated in a modified manner or is not evaluated. Evaluation in a modified manner may, in particular, consist of the structure being evaluated with reduced accuracy (e.g., in the case of a partial malfunction of a processing unit). If the structure is not evaluated, its result or output value (e.g., which is required for further calculations) may be replaced by a standard value, e.g., zero, or, if correlations between structures are known, by the output value of a strongly correlated (with the unevaluated structure) value or a value derived therefrom using the correlation.

In general, the calculations identified as highly critical (recognizable based on the criticality information) are transferred online to a still fully functional processing HW. Other, less critical calculations are then performed on (partially) faulty processing hardware.

Alternatively, they are discarded or replaced by mutual information as described in the previous configurations.

Methods are further described for determining criticality information of structures of a neural network that are evaluated using calculation assemblies (in particular hardware accelerators) (e.g., when applying the neural network to new data, so-called “inference”). Each calculation assembly may comprise one or more calculation units. The dimensions of these structures can range from a single weight to larger structures, e.g., neurons, filters, or channels. For example, in FIG. 3, the structure of a neural network is illustrated, wherein neurons 20, channels 22, shapes 24 (or detection thereof), filters 26, and a layer 28 are shown as structures. A pre-trained neural network (pruned or complete) is assumed and criticality information is determined for each structure of the neural network. In the following, the disclosure is explained as a structure based on a neuron, unless otherwise specified. However, it should be emphasized that the disclosure can also be applied to structures with more or fewer dimensions.

In a first configuration, the criticality is calculated using relevance metrics used in, for example, post-training pruning approaches, e.g., the L₁ metric (H. Li, A. Kadav, I. Durdanovic, H. Samet, and H. P. Graf, “Pruning filters for efficient convents”, arXiv preprint arXiv:1608.08710, 2016). The selected relevance metric is calculated for each structure, in this example for each neuron. The calculated relevance metric (also referred to as the relevance value) is used to progressively rank each structure according to its relevance, i.e., structures (here neurons) with the highest L₁ value are the most relevant and vice versa. These or similar relevance metrics (or relevance values) may also be provided using other methods, for example, resilience prediction methods from the area of the comprehensible AI domain, e.g., the method described in C. Schorn, A. Guntoro, and G. Ascheid, “Accurate neuron resilience prediction for a flexible reliability management in neural network accelerators”, in Design, Automation & Test in Europe Conference & Exhibition (DATE). IEEE, 2018, pp. 979-984.

In another configuration, the aforementioned criticality information may be derived (at least in part) with mutual information of the existing structures within each layer. This mutual information can be obtained, for example, by calculating the cross correlation and/or correlation between each structure in each layer. For example, for a layer with (h*w*ch) neurons (i.e., h*w neurons for ch channels), the correlation between all neurons is calculated and a correlation matrix of the size [h*w, ch] is determined. This mutual information is calculated offline. Online, i.e., when using the neural network, the least relevant structures may be dropped in case of (random) HW errors. Expediently, its output is not set to zero (or another particular value), but rather the (highly correlated) neuron with the highest correlation to the eliminated neuron may be determined and the output of this highly correlated neuron may replace the output of the eliminated neuron. An indication of strongly correlated (other) structures can be included in the criticality information as correlation information, for example. A replacement with the output of a highly correlated (other) structure results in a relatively small loss of information, or error.

Generally, an error measure (for instance as a measure of information loss) may be determined that indicates an average or maximum error occurring when the output of the structure is omitted or when the output of the structure is replaced by the output of a correlated structure. Such an error measure may be included in the criticality information of the structures. In an offline analysis, the number of structures per layer that can be omitted before a predefined performance tolerance T is no longer met can also be determined. If error measures are included in the criticality information of the structures, an expected overall error may be determined online from the respective error measures of the structures that are not evaluated or that are changed (e.g. replaced with correlated output or calculated with reduced accuracy), which should be below a predetermined maximum total error threshold, for example.

In a third configuration, the criticality information is determined based on the quantization sensitivity of the neural network. In determining the quantization configuration of the network (i.e., offline during the design time), the obtained sensitivity can be used to determine structures of the neural network that, when calculated with reduced accuracy, do not result in any loss of information or result in a relatively (to other structures) low loss of information. Corresponding information may be included as accuracy loss information in the criticality information of the structures. Essentially, the individual calculations of the network may be graded according to their relevance/criticality based on their impact on the algorithmic performance of the neural network when performed at reduced bit width. The ranking of the criticality can be determined by iteratively evaluating the quantization cost function for the layer, in which only a portion of the layer (e.g., a neuron, a segment, a channel, etc.) is evaluated with a reduced bit width.

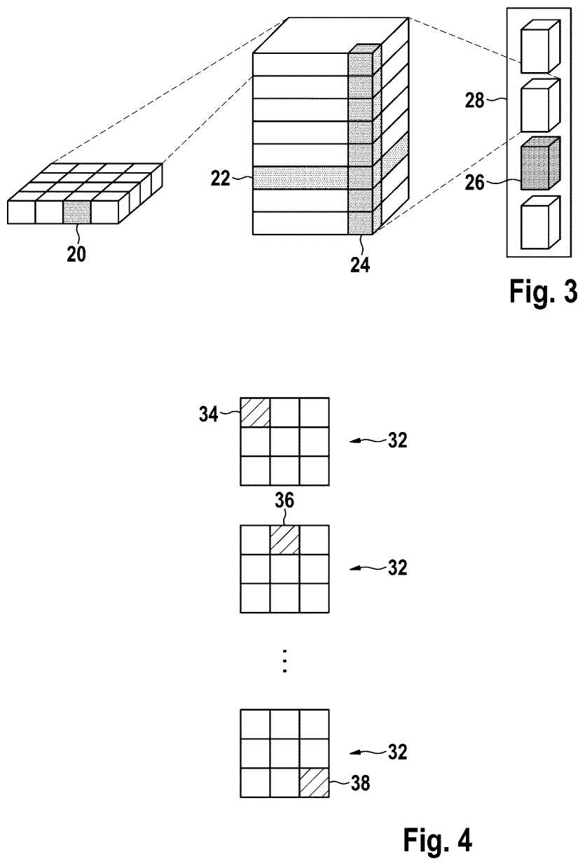

FIG. 4 graphically illustrates the determination of neuron evaluation errors with reduced accuracy. A neuron array 32 of 3×3 neurons is shown therein. Here, for each neuron 34, 36, 38, an error eᵢ is calculated with i ∈{1; 2; . . . ; n} that occurs when that neuron is evaluated with reduced accuracy (compared to a full accuracy evaluation). When evaluating a neuron, differently weighted input values are added up, for example, i.e., a multiply-add operation is performed. When evaluating with reduced accuracy, the multiply-add operation is performed, for instance, with half instead of full bit width. The criticality can then be determined based on the error. The error is determined here as a deviation, e.g., by way of the L₂ standard (squared deviation), between the evaluation in full bit width and the evaluation with half bit width. In FIG. 4, the respective neuron which is evaluated with reduced accuracy is shown shaded. The other neurons are evaluated with full accuracy. The error, e.g., the L₂ standard, is calculated based on the entirety of the output values of all neurons (e.g., as the L₂ vector standard; eᵢ=∥y−ŷ∥₂, wherein y represents the output values during an evaluation with full accuracy and ŷ represents the output values during an evaluation with reduced accuracy in one of the neurons, neuron i). The errors are applied to a variety of different input values (e.g., those used in the training) and then averaged, for example, to determine an expected error in case of non-evaluation for each neuron. Neurons exhibiting a large (expected) error may be considered more critical than others. The labeling of the criticality (also referred to as accuracy loss information) (calculated offline) may be used to determine which structures can be calculated in case of a HW error in a computation unit with reduced accuracy (e.g., bit width) without the resulting error becoming too large when evaluating the neural network.

Further, different accuracies and/or quantizations may be considered even when designing the neural network. For example, if y represents the output values when evaluated with full accuracy (e.g., floating-point arithmetic), ŷ₁ represents the output values when evaluated with reduced accuracy compared to the full accuracy (e.g., full bit width of the processing units) and ŷ₂ represents the output values when evaluated with accuracy which is further reduced compared to this reduced accuracy (e.g., half the bit width of the processing units), then optimizations can be made during the design in which this further reduced accuracy is taken into account. For example, the following cost function may be considered in the design of the neural network: J=(1−α)∥yŷ₁∥₂−α·∥y−ŷ₂∥₂; wherein α is a weight factor that may be set according to desired requirements.

The configuration of the network may be optimized such that the performance of the network is sufficient not only for normal error-free operation but also when during execution in an operation mode which may be subject to errors on (partially) faulty processing units. In other words, the mapping may be implemented so that cost function J, which compares costs for an evaluation at full accuracy and costs for an evaluation at reduced accuracy, is optimized (i.e., comes as close as possible to a desired target value), in particular minimized.

What is claimed is:

1. A method for fault tolerant implementation of a mapping of at least one input value to at least one output value by a processing assembly having a plurality of processing units,
wherein the mapping comprises a plurality of structures having computational operations that can be evaluated by one or more of the processing units, and wherein each of the structures is associated with criticality information including information on how critical the error-free evaluation of the structure is for error-free evaluation of the mapping;
wherein, when at least one processing unit has a malfunction, at least one structure is selected based on the criticality information of the structures, and wherein it is determined whether the at least one structure is to be evaluated in a modified manner or not to be evaluated; and
wherein the mapping is applied to input values, and wherein the selected at least one structure is evaluated in a modified manner or is not evaluated.

2. The method according to claim 1, wherein:
the criticality information of each structure includes a relevance value,
the at least one structure is selected according to the relevance values of the structures, and
the selected at least one structure has a lowest relevance value and/or a relevance value below a predetermined relevance value threshold.

3. The method of claim 1, wherein the criticality information of each structure includes an error measure indicative of an expected average or maximum error of the mapping when the structure changed is evaluated differently or is not evaluated.

4. The method according to claim 3, wherein:
the at least one structure is selected according to the error measures of the structures, and
the selected at least one structure has a low error measure and/or an error measure below a predetermined error measure threshold.

5. The method according to claim 3, wherein an expected overall error of the mapping is determined based on the error measure of the selected at least one structure, and the expected overall error is output and/or transmitted to a function module that processes the result of the mapping.

6. The method according to claim 1,
wherein the mapping implements a neural network, and wherein the structures include weights and multiplication by weights, neurons, layers, or channels, and/or
wherein the structures are multiply-add operations, and wherein the processing units are configured to perform multiply-add operations.

7. The method of claim 1, wherein each processing unit is configured to evaluate a structure or a portion thereof with different accuracies, and wherein each processing unit is configured to evaluate the structure with reduced accuracy in case of a partial malfunction of the processing unit and/or to evaluate the structure in parallel two or more times with reduced accuracy in each case, and wherein the selected at least one structure is evaluated in a modified manner with reduced accuracy.

8. The method according to claim 7, wherein the criticality information of each structure includes an accuracy loss information which indicates a loss of accuracy of the structure when evaluated with reduced accuracy, wherein the selection of the at least one structure corresponds to the accuracy loss information of the structures, and wherein the selected at least one structure has a low accuracy loss and/or an accuracy loss below a predetermined accuracy loss threshold.

9. The method according to claim 8, wherein the mapping is implemented so that a cost function comparing costs for an evaluation at full accuracy and costs for an evaluation at reduced accuracy is optimized.

10. The method according to claim 7, wherein the different accuracies correspond to different quantizations of values.

11. The method according to claim 1, wherein the criticality information of each structure includes a correlation information, which indicates at least one other structure whose result values are strongly correlated to the result values of the structure, and wherein, when applying the mapping to the input values, the at least one structure is not evaluated and estimated result values are determined from result values of the at least one other structure using the correlation information, which are used instead of the result values of the non-evaluated structure.

12. The method according to claim 1, wherein the criticality information of each structure includes resource information, which indicates what computational power resources are conserved and to what extent, if the structure is not evaluated or is evaluated in a modified manner, and wherein a computational power loss, caused by the malfunction of the at least one processing unit, is determined, and wherein the at least one structure is selected such that the saved computational power resources balance out the computational power loss or balance it out within a predetermined tolerance.

13. The method according to claim 1,
wherein a distribution table mapping structures to processing units is provided, and wherein the distribution table is modified so that the selected at least one structure is not evaluated or is evaluated in a modified manner, or
wherein a distribution function is implemented, wherein structures to be evaluated are dynamically assigned to processing units taking into account the criticality information, and wherein the at least one structure is selected in response to an application duration of the mapping reaching or exceeding a predetermined maximum duration.

14. The method according to claim 1, wherein it is determined whether each of the processing units has a malfunction.

15. A processing assembly comprising a plurality of processing units and a control unit configured to perform all method steps of a method according to claim 1.

16. A computing unit configured to carry out all method steps of a method according to claim 1.

17. A computer program causing a computing unit to carry out all method steps of a method according to claim 1 when it is evaluated on the computing unit.

18. A machine-readable storage medium having a computer program according to claim 17 stored thereon.

19. The method according to claim 8, wherein the mapping is implemented so that a cost function comparing costs for an evaluation at full accuracy and costs for an evaluation at reduced accuracy is minimized.

20. The method according to claim 7, wherein the different accuracies correspond to different bit widths.
